(19) United States
(12) Patent Application Publication
(10) Pub. No.: US 2016/0093068 A1
(43) Pub. Date: Mar. 31, 2016

(54) IMAGE MEASUREMENT APPARATUS AND GUIDANCE DISPLAY METHOD OF IMAGE MEASUREMENT APPARATUS

(71) Applicant: MITUTOYO CORPORATION, Kanagawa (JP)

(72) Inventors: Yu SUGAI, Kawasaki (JP); Akira TAKADA, Yokohama (JP); Takashi HANAMURA, Hadano (JP)

(73) Assignee: MITUTOYO CORPORATION, Kanagawa (JP)

(21) Appl. No.: 14/857,165

(22) Filed: Sep. 17, 2015

(30) Foreign Application Priority Data
Sep. 29, 2014 (JP) 2014-197925

(51) Int. Cl. G06T 7/60; H04N 5/232

(52) U.S. Cl. CPC G06T 7/60; H04N 5/23229; H04N 5/23293; G06T 2207/10004

(57) ABSTRACT

An image measurement apparatus according to the present invention includes: an image capturer obtaining an image of an object to be measured; a display displaying the image obtained by the image capturer; a measurer performing a measurement selected by an operator based on the image displayed on the display; a guidance display portion displaying an operation sequence for the measurement on the display; and a step display portion displaying, on the display, a pattern corresponding to an operation step in the operation sequence. The step display portion displays a step display for each of the operation steps in a circular form in operation order as the pattern.

### CROSS-REFERENCE TO RELATED APPLICATIONS

The present application claims priority under 35 U.S.C. §119 of Japanese Application No. 2014-197925, filed on Sep. 29, 2014, the disclosure of which is expressly incorporated by reference herein in its entirety.

### BACKGROUND OF THE INVENTION

1. Field of the Invention

The present invention relates to an image measurement apparatus and guidance display method of the image measurement apparatus providing a guidance display which communicates an operation sequence for a measurement to an operator.

2. Description of Related Art

An image measurement apparatus obtains an image of an object to be measured and measures a desired dimension of the object using an image of the object shown on a display screen. An image measurement apparatus of this kind may include a guidance display function displaying an operation method on the display screen showing the image of the object and providing notification to the operator, or a function displaying a help screen (see, e.g., Japanese Patent Laid-open Publication Nos. 2013-195216 and H07-129371).

The guidance display function displays on the display screen a measurement procedure corresponding to a measurement mode selected by the operator. For example, in a mode where a rectangular hole is measured, four sides of the rectangular hole to be measured must be designated in order on the image of the object displayed on the display screen. In the guidance display function, guidance is displayed on the display screen in accordance with a task sequence for designating the four sides.

In an image measurement apparatus having a guidance display function of this kind, the operator progresses through a measurement task while referring to the guidance displayed on the display screen; however, the operator's progress through the measurement task is difficult to comprehend intuitively. In other words, in a case where a measurement is performed having a large number of task steps, the operator can comprehend the nature of the tasks using the guidance display; however, the display does not facilitate ready understanding of how far into the total task the current task step is.

The present invention provides an image measurement apparatus and a guidance display method of the image measurement apparatus which enable the progress of a measurement task to be readily comprehended when performing guidance display.

### SUMMARY OF THE INVENTION

An image measurement apparatus according to the present invention includes: an image capturer obtaining an image of an object to be measured; a display displaying the image obtained by the image capturer; a measurer performing a measurement selected by an operator based on the image displayed on the display; a guidance display portion displaying an operation sequence for the measurement on the display; and a step display portion displaying a pattern corresponding to an operation step in the operation sequence. The step display portion displays a step display for each of the operation steps in a circular form in operation order as the pattern.

According to this configuration, in addition to the guidance display showing the operation sequence for the measurement, each step display in the operation sequence is displayed in a circular form in operation order. Therefore, a total number of steps can be readily comprehended.

In the image measurement apparatus according to the present invention, the step display portion may also display a current step display corresponding to the current operation in a different format from the other step displays. According to this configuration, the current step display corresponding to the current operation is displayed in a different format from the other step displays. Therefore, the current step can be readily comprehended among all the steps.

In the image measurement apparatus according to the present invention, the step display portion may also display the current step display and the other step displays at mutually different area ratios. According to this configuration, the current step display and the other step displays can be accurately distinguished based on the difference in area ratio.

In the image measurement apparatus according to the present invention, the step display portion may also display the current step display in a different color from the other step displays. According to this configuration, the current step display can be emphasized among the step displays with a different color, providing a more easily viewable display.

In the image measurement apparatus according to the present invention, the step display portion may also display the current step display with a larger size than the other step displays. According to this configuration, the current step display can be emphasized among the step displays as larger, providing a more easily viewable display.

In the image measurement apparatus according to the present invention, the step display portion may also display a step earlier in the operation order than the current step display in a paler color than the current step display. According to this configuration, the step display for an operation that has already been completed can be displayed so as to not be eye-catching.

In the image measurement apparatus according to the present invention, the step display portion may also display a step later in the operation order than the current step display in a paler color than the current step display and in a different color from that of the step display earlier in the operation order than the current step display. According to this configuration, the step display for an operation yet to be performed and the step display for an operation that has already been completed can be accurately recognized as opposed to the current step display.

In the image measurement apparatus according to the present invention, the step display portion may also display all of the step displays arranged as one complete circle as the pattern. According to this configuration, a more easily viewable display can be provided of all the step displays as one complete circle regardless of the number of operation steps.

In the image measurement apparatus according to the present invention, the step display portion may also display each of the step displays as individual pie-shaped (also referred to as fan-shaped) segments. According to this configuration, each step display in the operation sequence is displayed as a pie chart.

A guidance display method of an image measurement apparatus according to the present invention, which obtains and displays an image of an object to be measured on a display and performs a measurement based on the image displayed on the display, the apparatus displaying an operation sequence for a measurement and a pattern corresponding to an operation step of the operation sequence, the operation sequence and the pattern being displayed on the display of the image measurement apparatus. Each step display of the operation steps is displayed in a circular form in operation order as the pattern, and a current step display corresponding to the current operation step is displayed in a different format from the other step displays.

According to this configuration, when providing the guidance display showing the operation sequence for the measurement, each step display in the operation sequence is displayed in a circular form in operation order. Therefore, a display can be provided enabling a total number of steps to be readily comprehended.

In the guidance display method of the image measurement apparatus according to the present invention, the step display portion may also display the current step display corresponding to the current operation in a different format from the other step displays. According to this configuration, the current step display corresponding to the current operation is displayed in a different format from the other step displays. Therefore, a display can be provided enabling the current step to be readily comprehended among all the steps.

In the guidance display method of the image measurement apparatus according to the present invention, the current step display and the other step displays may also be displayed at mutually different area ratios as the pattern. According to this configuration, a display can be provided enabling the current step display and the other step displays to be accurately distinguished based on the difference in area ratio.

In the guidance display method of the image measurement apparatus according to the present invention, the current step display may also be displayed in a different color from the other step displays as the pattern. According to this configuration, the current step display can be emphasized among the step displays with a different color, providing a more easily viewable display.

In the guidance display method of the image measurement apparatus according to the present invention, the current step display may also be displayed with a larger size than the other step displays as the pattern. According to this configuration, the current step display can be emphasized among the step displays as larger, providing a more easily viewable display.

In the guidance display method of the image measurement apparatus according to the present invention, a step display earlier in the operation order than the current step display may also be displayed in a paler color than the current step display as the pattern. According to this configuration, the step display for an operation that has already been completed can be displayed so as to not be eye-catching.

In the guidance display method of the image measurement apparatus according to the present invention, a step display later in the operation order than the current step display may also be displayed in a paler color than the current step display and in a different color from that of the step display earlier in the operation order than the current step display as the pattern. According to this configuration, the step display for an operation yet to be performed and the step display for an operation that has already been completed can be accurately recognized as opposed to the current step display.

In the guidance display method of the image measurement apparatus according to the present invention, all of the step displays may also be displayed arranged as one complete circle as the pattern. According to this configuration, a more easily viewable display can be provided of all the step displays as one complete circle regardless of the number of steps in the operation sequence.

In the guidance display method of the image measurement apparatus according to the present invention, each of the step displays may also be displayed as individual pie-shaped segments as the pattern. According to this configuration, each step display in the operation sequence can be displayed as a pie chart.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view illustrating an exemplary image measurement apparatus according to a first embodiment;

FIG. 2A is functional block diagram of the image measurement apparatus; FIG. 2B is a functional block diagram of a computer system;

FIG. 3 illustrates an exemplary screen display using a guidance display portion and a step display portion;

FIG. 4 is an expanded view of a portion of the screen display;

FIGS. 5A to 5F illustrate exemplary patterns;

FIGS. 6A to 6D illustrate additional exemplary patterns;

FIGS. 7A to 7H illustrate exemplary patterns in cases where a number of operation steps is “5” or more;

FIGS. 8A and 8B illustrate additional exemplary perimeter shapes;

FIG. 9 illustrates an exemplary measurement operation and guidance display;

FIG. 10 illustrates an exemplary measurement operation and guidance display;

FIG. 11 illustrates an exemplary measurement operation and guidance display;

FIG. 12 illustrates an exemplary measurement operation and guidance display;

FIG. 13 illustrates an exemplary measurement operation and guidance display;

FIG. 14 illustrates an exemplary measurement operation and guidance display;

FIG. 15 illustrates an exemplary measurement operation and guidance display;

FIG. 16 illustrates an exemplary measurement operation and guidance display; and

FIG. 17 is a flow chart illustrating an exemplary flow of an image measurement program.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereafter, an embodiment of the present invention is described with reference to the drawings. In the present specification and the respective drawings, the same reference numerals are given to elements that are the same as those described with regard to a described drawing, and a detailed description of the elements is omitted.

Configuration of Apparatus

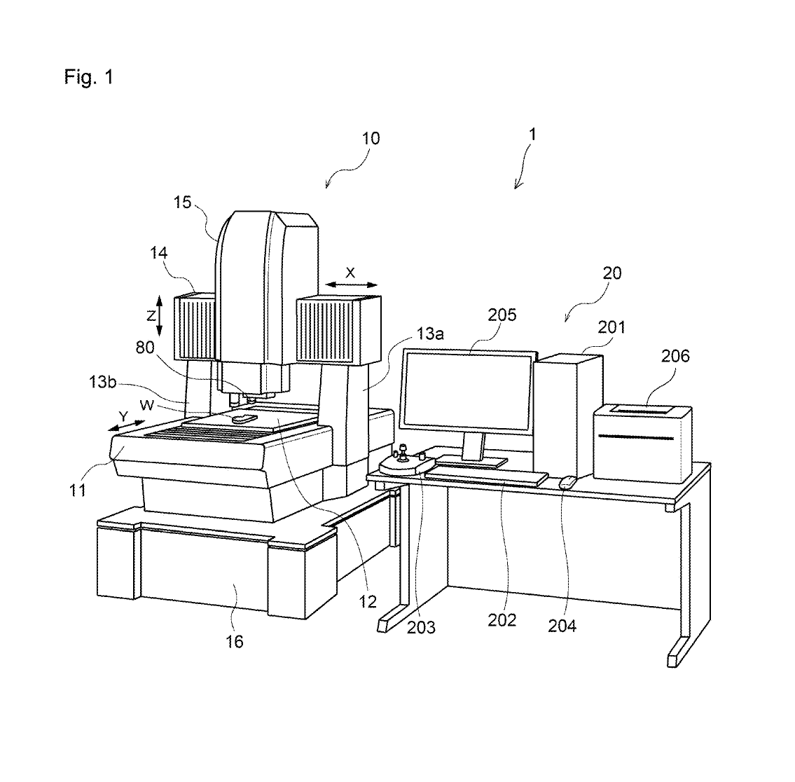

FIG. 1 is a perspective view illustrating an exemplary image measurement apparatus according to the present embodiment. As shown in FIG. 1, an image measurement apparatus 1 according to the present embodiment is an apparatus that obtains an image of a work piece W (object to be measured) and performs a measurement of a dimension, shape, or the like of a predetermined portion of the work piece W based on the obtained image.

The image measurement apparatus 1 includes a device main body 10 and a computer system 20. The device main body 10 includes a table 11, a stage 12, an X-axis guide 14, and an image capture unit 15. The table 11 is positioned atop an anti-vibration table 16, for example, and inhibits external vibrations from being transmitted to the stage 12 on the table 11 and to the image capture unit 15.

The stage 12 is positioned above the table 11. The stage 12 is a platform on which the work piece W is placed. The stage 12 is provided so as to be capable of being displaced by a Y-axis drive mechanism (not shown in the drawings) in a Y axis direction (direction following the Y axis) with respect to the table 11.

Supports 13a and 13b are provided on two side portions of the table 11. Each of the supports 13a and 13b are provided so as to extend vertically upward from the side portions of the table 11. The X-axis guide 14 is provided straddling atop the supports 13a and 13b. The image capture unit 15 is attached to the X-axis guide 14. The image capture unit 15 is provided so as to be capable of being displaced along the X-axis guide 14 by an X-axis drive mechanism (not shown in the drawings) in an X axis direction (direction following the X axis).

The image capture unit 15 is provided so as to be capable of being displaced by a Z-axis drive mechanism (not shown in the drawings) in a Z axis direction (direction following the Z axis). With this configuration, a relative positional relationship between the work piece W on the stage 12 and the image capture unit 15 can be defined along each of the X, Y, and Z axes. In other words, by adjusting this positional relationship, an image capture region of the image capture unit 15 can be matched to a measurement region of the work piece W.

The computer system 20 includes a computer main body 201, a keyboard 202, a joystick 203, a mouse 204, a display 205, and a printer 206. The computer main body 201 controls operations of the device main body 10 and the like. The computer main body 201 controls the operations of the device main body 10 using a circuit such as a control board (hardware) and a program executed by a CPU (software). In addition, the computer main body 201 calculates data for the work piece W based on a signal output from the device main body 10, and displays the calculation result on the display 205.

The joystick 203 is used when defining the image capture region for the work piece W. Specifically, a user operates the joystick 203 and can thereby change the relative positional relationship between the work piece W and the image capture unit 15, and can adjust the position of the image capture region displayed on the display 205.

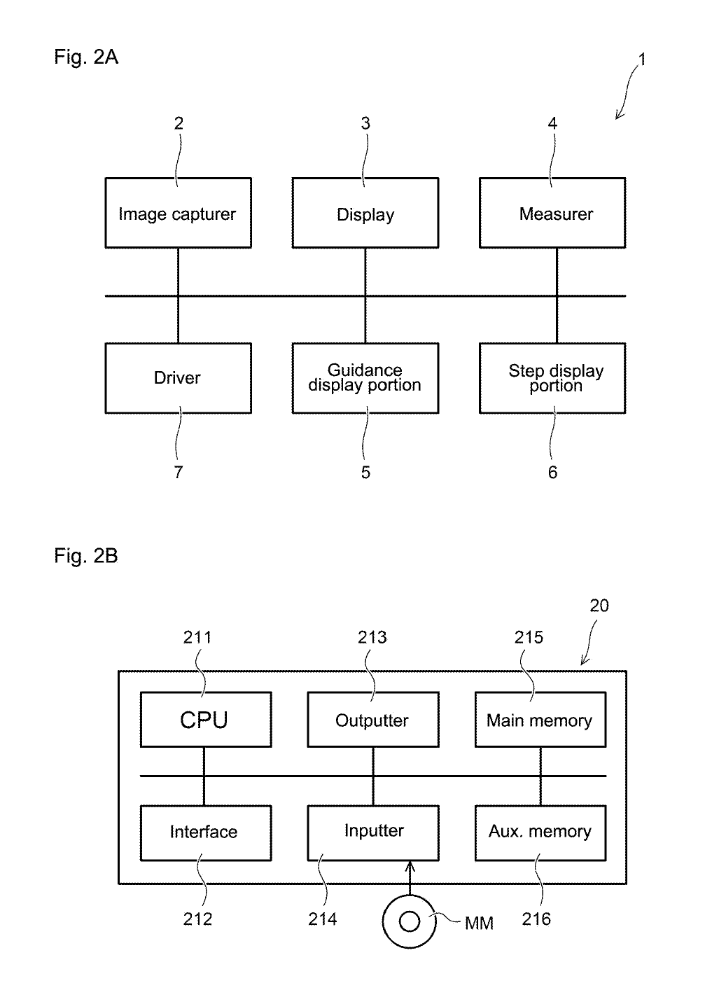

FIG. 2A is functional block diagram of the image measurement apparatus 1. FIG. 2B is a functional block diagram of the computer system 20. As shown in FIG. 2A, an image capturer 2, a display portion 3, a measurer 4, a guidance display portion 5, a step display portion 6, and a driver 7 are provided, represented as functional blocks of the image measurement apparatus 1.

The image capturer 2 obtains an image of the work piece W, and corresponds to the image capture unit 15 shown in FIG. 1. The display portion 3 displays the image obtained by the image capturer 2, and corresponds to the display 205 shown in FIG. 1. The measurer 4 performs a measurement selected by an operator based on the image displayed on the display portion 3. In the present embodiment, the measurer 4 is provided using a program executed by the computer main body 201 shown in FIG. 1.

The guidance display portion 5 performs a process to display an operation sequence related to measurement on the display portion 3. The step display portion 6 performs a process to display a pattern corresponding to an operation step in the operation sequence on the display portion 3. In the present embodiment, the guidance display portion 5 and the step display portion 6 are provided using a program executed by the computer main body 201 shown in FIG. 1. A detailed description of the guidance display portion 5 and the step display portion 6 follows.

The driver 7 drives the stage 12 and the image capture unit 15 in an image capture range of the work piece W in accordance with a program executed by the computer main body 201, for example. The driver 7 also drives the stage 12 and the image capture unit 15 in response to operation of the joystick 203 by the operator.

Moreover, as shown in FIG. 2B, a CPU (Central Processing Unit) 211, interface 212, outputter 213, inputter 214, main memory 215, and auxiliary memory 216 are provided as functional blocks of the computer system 20.

The CPU 211 controls various components by executing various programs. The interface 212 performs data input/output with respect to an external device. In the present embodiment, data sent from the device main body 10 is imported into the computer system 20 via the interface 212. In addition, data is sent from the computer system 20 to the device main body 10 via the interface 212. The interface 212 may also connect the computer system 20 to a LAN (Local Area Network) or WAN (Wide Area Network).

The outputter 213 outputs results of processing by the computer system 20. The display 205 or the printer 206 shown in FIG. 1, for example, may be used as the outputter 213. The inputter 214 receives data from the operator. The keyboard 202, the joystick 203, or the mouse 204 shown in FIG. 1, for example, may be used as the inputter 214. The inputter 214 also reads data stored in a memory medium MM.

A RAM (Random Access Memory) may be used as the main memory 215, for example. A portion of the auxiliary memory 216 may also be used as a portion of the main memory 215. An HDD (Hard Disk Drive) or SSD (Solid State Drive) may be used as the auxiliary memory 216, for example. The auxiliary memory 216 may also be an external memory device connected via a network.

Screen Display

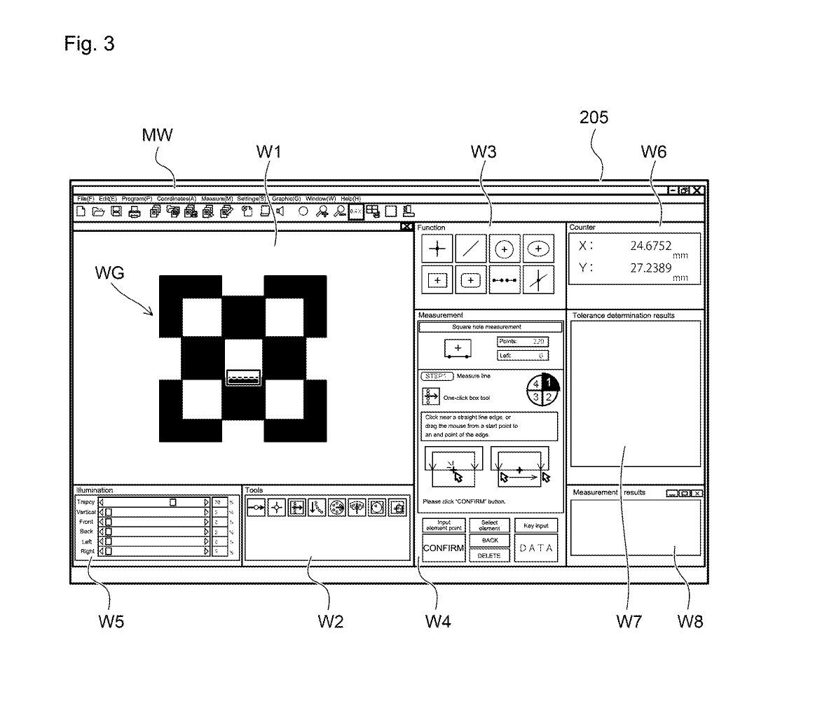

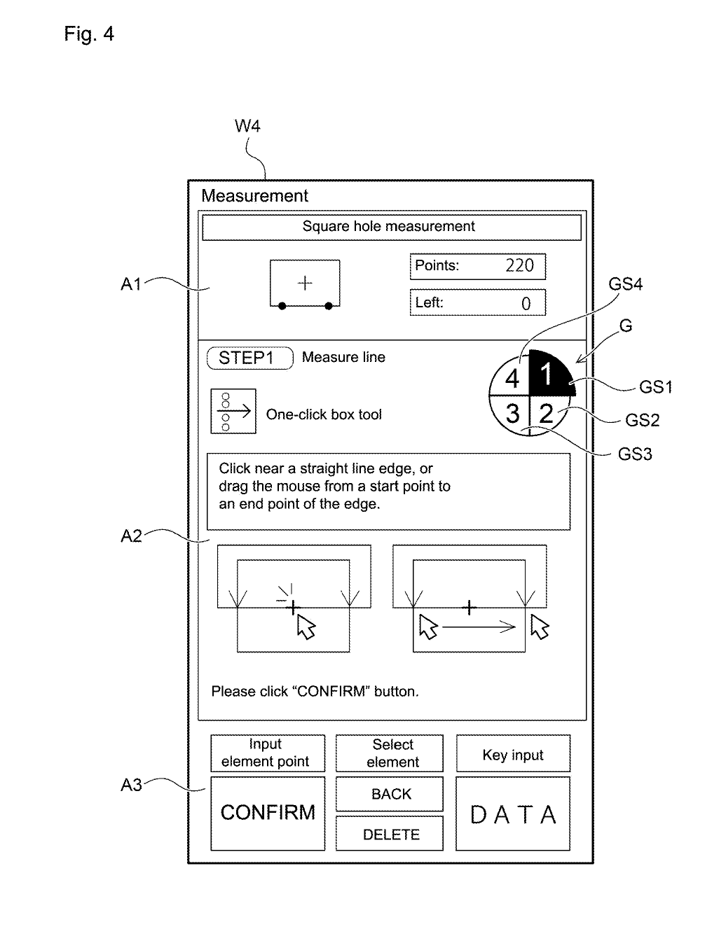

Next, a screen display using the guidance display portion 5 and the step display portion 6 is described. FIG. 3 illustrates an exemplary screen display using a guidance display portion and a step display portion. FIG. 4 is an expanded view of a portion of the screen display. These screen displays are rendered on the display 205 by a program (measurement application software) executed by the CPU 211 of the computer main body 201.

As shown in FIG. 3, a main window MW is displayed on the display 205 by executing the program. In addition, a plurality of windows (first window W1 through eighth window W8) are displayed within the main window MW. A menu and icons for various operations and settings are also displayed on an upper portion of the main window MW. The present embodiment describes an example where eight windows are displayed; however, displays of other than eight windows are also possible, according to the requirements of an embodiment. In addition, a layout of the various windows can be freely changed through an operation by the operator.

An image WG of the work piece W, imported by the image capture unit 15, is displayed in the first window W1. By operating the joystick 203, for example, the operator can adjust a position of the image WG of the work piece W displayed in the first window W1. The operator can also zoom in and zoom out on the image WG of the work piece W by selecting an icon with the mouse 204, for example.

Icons of tools that the operator can select are displayed in the second window W2. The tool icons provided correspond to methods for designating a measurement point on the image WG of the work piece W.

Icons of functions that the operator can select are displayed in the third window W3. A function icon is provided for each measurement method. Examples include a method measuring coordinates of one point; a method measuring a length of a straight line; a method measuring a circle; a method measuring an ellipse; a method measuring a square hole; a method measuring an elongated hole; a method measuring pitch; or a method measuring an intersection of two lines.

A fourth window W4 displays guidance indicating an operation sequence related to the measurement, and also displays a pattern G corresponding to the operation step. The guidance display of the fourth window W4 is performed by the guidance display portion 5, and the pattern G is displayed by the step display portion 6. The guidance display and display of the pattern G are described below.

A fifth window W5 displays various sliders for controlling illumination striking the work piece W from the image capture unit 15. By operating the sliders, the operator can provide the desired illumination to the work piece W.

A sixth window W6 displays XY coordinate values of the stage 12. The XY coordinate values displayed in the sixth window W6 are X axis direction coordinates and Y axis direction coordinates of the stage 12 relative to a predetermined origin point.

A seventh window W7 displays tolerance determination results. In other words, in a case where a measurement method capable of performing a tolerance determination is selected, the seventh window W7 displays those results.

An eighth window W8 displays measurement results. In other words, in a case where a measurement method obtaining measurement results using a predetermined calculation is selected, the eighth window W8 displays those results. Detailed depictions of the tolerance determination results display in the seventh window W7 and the measurement results display in the eighth window W8 are omitted from the drawings.

The guidance display and display of the pattern G in the fourth window W4 are described below. FIG. 4 is an expanded view of the fourth window W4. The fourth window W4 is divided into, for example, a first area A1 through third area A3. The measurement method selected by the operator and data for a designated location required to perform measurement with that measurement method are both displayed in the first area A1.

The operation sequence (guidance) related to the measurement selected by the operator is displayed in the second area A2. The guidance display portion 5 performs a process to display guidance corresponding to the operation sequence in the second area A2. Specifically, guidance (using words and images) is displayed for the current operation step, a designation method using the mouse 204. The guidance display portion 5 automatically switches the guidance display in accordance with the operation step. The operator designates a measurement location on the image WG of the work piece W while referring to the guidance display.

Buttons (icons) for various operations are displayed in the third area A3. By selecting a desired icon using the mouse 204 or the like, the operator can execute the selected operation.

In the present embodiment, the step display portion 6 performs a process to display the pattern G corresponding to the operation step in the fourth window W4. The pattern G is displayed within the second area A2, for example, where the guidance is displayed. As the pattern G, the step display portion 6 performs a process to display each of the operation steps (for example, GS1 to GS4) in operation order in a circular shape.

In the example shown in FIG. 4, the operation sequence comprises four operation steps. Therefore, the step display portion 6 displays the first through fourth step displays GS1 to GS4, corresponding to the four operation steps, in clockwise order, for example, around a circular shape. The step display portion 6 changes the pattern G displayed in accordance with the measurement method selected by the operator. In other words, the step display portion 6 displays the pattern G that corresponds to the number of operation steps in the measurement method selected by the operator (the function selected in the third window W3). By displaying such a pattern G, the operator can readily comprehend the guidance display displayed in the fourth window W4 as well as the total number of steps in the selected measurement method.

Exemplary Patterns

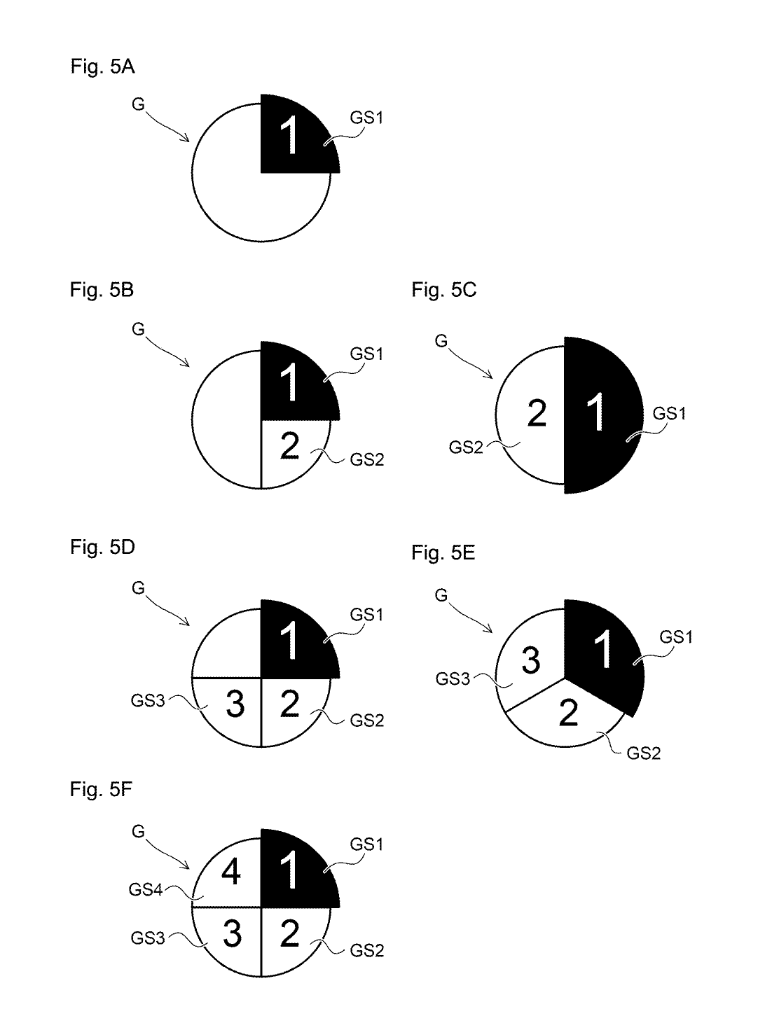

Next, examples of patterns are described. FIGS. 5A to 5F illustrate exemplary patterns. FIG. 5A depicts an exemplary pattern G for a case where the number of operation steps is “1.” In the pattern G shown in FIG. 5A, the first step display GS1 is represented by a pie shape occupying approximately 90° of the circle.

FIGS. 5B and 5C depict an exemplary pattern G for a case where the number of operation steps is “2.” In the pattern G shown in FIG. 5B, the first step display GS1 and the second step display GS2 are represented by pie shapes each occupying approximately 90° of the circle. In this pattern G, the first step display GS1 and the second step display GS2 are displayed in order clockwise around the circle. In addition, in the pattern G shown in FIG. 5C, the entire circle is divided into two parts to which the first step display GS1 and the second step display GS2 are respectively assigned.

FIGS. 5D and 5E depict an exemplary pattern G for a case where the number of operation steps is “3.” In the pattern G shown in FIG. 5D, the first step display GS1, the second step display GS2, and the third step display GS3 are represented by pie shapes each occupying approximately 90° of the circle. In this pattern G, the first step display GS1, the second step display GS2, and the third step display GS3 are displayed in order clockwise around the circle. In addition, in the pattern G shown in FIG. 5E, the entire circle is divided into three parts to which the first step display GS1, the second step display GS2, and the third step display GS3 are respectively assigned.

FIG. 5F depicts an exemplary pattern G for a case where the number of operation steps is “4.” In the pattern G shown in FIG. 5F, the first step display GS1, the second step display GS2, the third step display GS3, and the fourth step display GS4 are represented by pie shapes each occupying approximately 90° of the circle.

By displaying each of the operation steps in a pie shape and arranging the step displays in a circular form, the operation steps are shown as a pie chart and the number of operation steps can be readily understood.

When the size of a single step display is fixed regardless of the number of operation steps, as in the patterns G shown in FIGS. 5A, 5B, 5D, and 5F, the step display is always the same size, enabling the operator to identify the single step display.

Also, by displaying all of the step displays arranged in one complete circle, as in the patterns G shown in FIGS. 5C, 5E, and 5F, the operator can more readily see all the step displays as one complete circle regardless of the number of operation steps, and can also more readily comprehend a ratio of a single step display relative to the whole.

In addition, in a case where a plurality of step displays are shown in the pattern G, as in the patterns G shown in FIGS. 5C to 5G, the step display corresponding to the current operation (current step display) may be displayed in a different format from the other step displays. For example, in the patterns G shown in FIGS. 5C to 5G, the first step display GS1 is the current step display. A size (area ratio, for example) or color of the first step display GS1, which is the current step display, may be displayed with a size (area ratio, for example) or color different from the other step displays.

As one example, in the patterns G shown in FIGS. 5D and 5E, the size (diameter of the pie shape) of the first step display GS1 is larger than the size (diameter of the pie shape) of the second step display GS2 and the third step display GS3. In addition, the color of the first step display GS1 is also different from the color of the second step display GS2 and the third step display GS3. Using such a display, the current step display is emphasized and the operator can readily comprehend which of the steps is the current step.

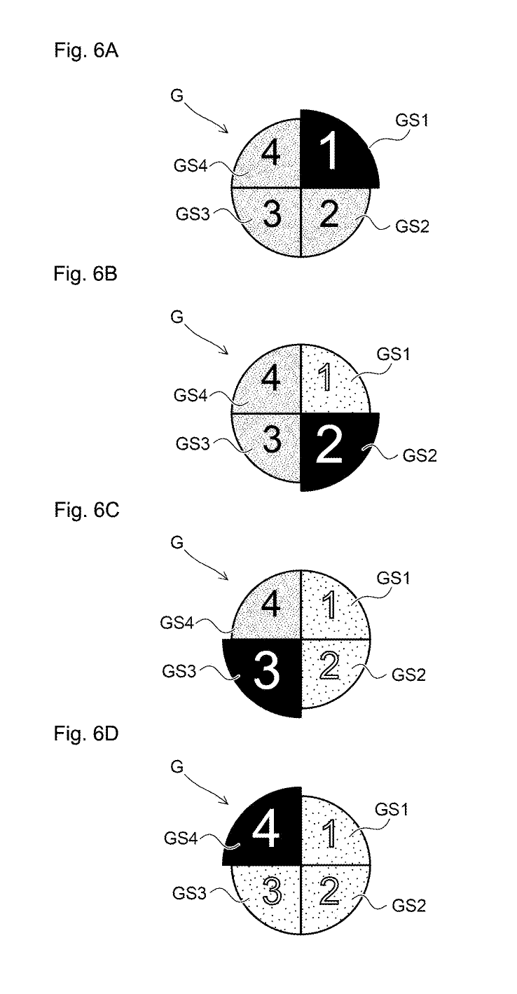

FIGS. 6A to 6D illustrate additional exemplary patterns. FIGS. 6A to 6D depict an exemplary display of an order of steps in the pattern G for a case where the number of operation steps is “4.” In other words, the current step display changes in order from the first step display GS1 to the fourth step display GS4 through FIGS. 6A to 6D, in order.

In such a pattern G where the current step display changes in operation step order, the display of a step earlier in the operation order than the current step display (completed step display) may be displayed in a different format from the current step display. For example, the completed step display may be displayed in a color paler than the current step display.

In the pattern G shown in FIG. 6B, the second step display GS2 is the current step display and the first step display GS1 is the completed step display. In this case, the second step display GS2 is shown in a comparatively dark color, while the first step display GS1 is shown in a comparatively pale color. The patterns G shown in FIGS. 6C and 6D are similar to that of FIG. 6B. Accordingly, the step display for operations that have already been completed is not eye-catching, enabling the operator to identify them.

In addition, the display of a step later in the operation order than the current step display (pending step display) may be displayed in a different format from the current step display. For example, the pending step display may be displayed in a different color from the current step display or in a color paler than the current step display. The pending step display is preferably displayed in a different format from the completed step display (for example, a different color). Accordingly, the operator can more readily identify the step display for an operation yet to be performed as opposed to the current step display.

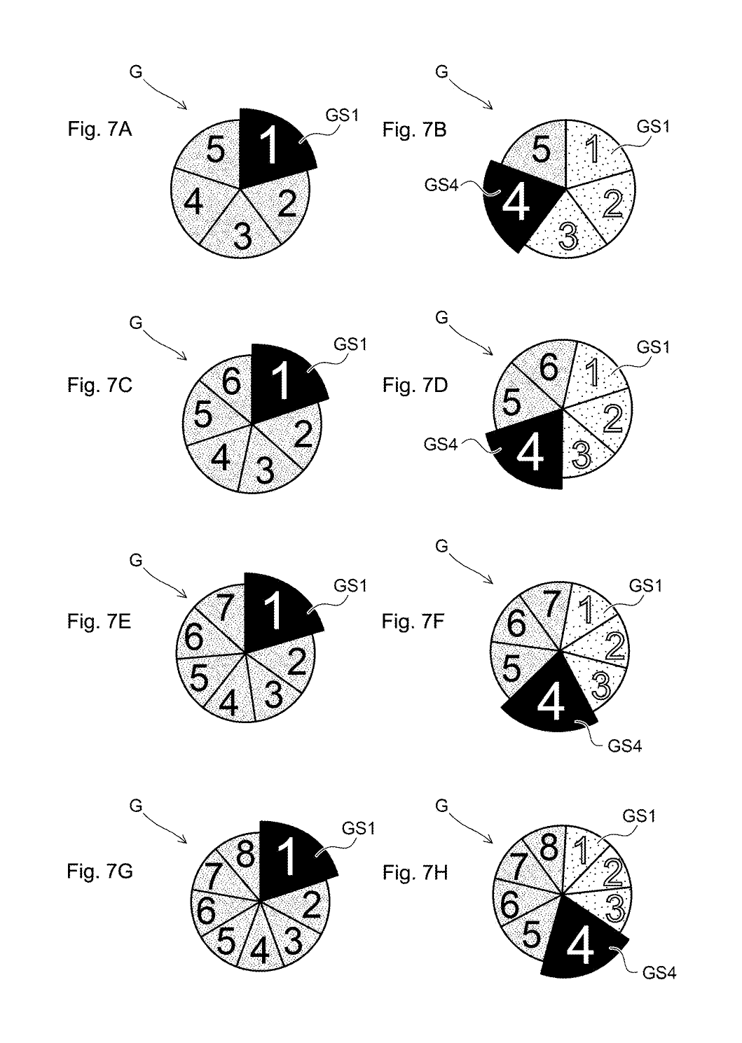

FIGS. 7A to 7H illustrate exemplary patterns in cases where the number of operation steps is “5” or more. FIGS. 7A and 7B illustrate an exemplary pattern G for a case where the number of operation steps is “5.” FIGS. 7C and 7D illustrate an exemplary pattern G for a case where the number of operation steps is “6.” FIGS. 7E and 7F illustrate an exemplary pattern G for a case where the number of operation steps is “7.” FIGS. 7G and 7H illustrate an exemplary pattern G for a case where the number of operation steps is “8.” In addition, FIGS. 7A, 7C, 7E, and 7G illustrate a case where the current step display is the first step display GS1, whereas FIGS. 7B, 7D, 7F, and 7H illustrate a case where the current step display is the fourth step display GS4.

In any of these cases, the circle is divided into the number of operation steps and each step display is assigned to each segment. In this example, the circle is divided into pie-shaped segments, and as the number of operation steps increases, a center angle of each pie-shaped segment becomes smaller. The step display representing the current step display may also be displayed such that the center angle of the pie-shaped segment is larger than that of the other step displays. Accordingly, the total number of steps as well as the current step display can be accurately identified by displaying the current step display as larger.

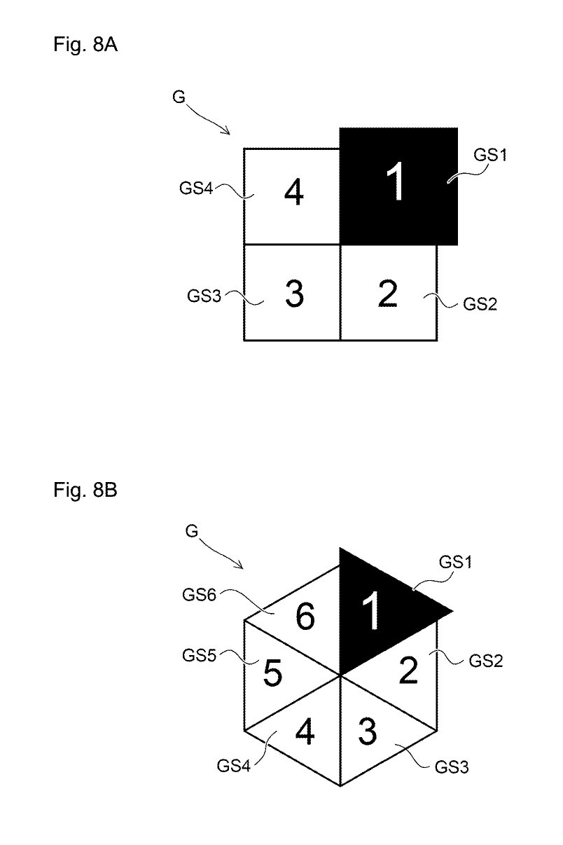

FIGS. 8A and 8B illustrate additional exemplary perimeter shapes. FIG. 8A shows a pattern G in which four step displays (first step display GS1 to fourth step display GS4) are given within a square perimeter. FIG. 8B shows a pattern G in which six step displays (first step display GS1 to sixth step display GS6) are given within a hexagonal perimeter. In this way, the perimeter shape of the pattern G is not limited to a circular shape, but may be configured with a polygonal shape corresponding to the number of operation steps. In any case, the current step display, completed step display, and pending step display are preferably displayed in a format similar to those given in the preceding description.

In the above, an example was described in which the formats of the current step display, completed step display, and pending step display differed in color and shade. However, the formats may also differ in brightness or saturation of a color; may be displayed in complementary colors; differ due to movement, such as whether the step display is flashing; or the like.

In the preceding, specific examples of various patterns G were described; however, an icon function may also be added to the patterns G. The icon function imparts an ability to each step display of the pattern G to move to the operation step corresponding to the selected step display, for example. Accordingly, in a case where the operator wishes to return to a completed step, for example, by selecting that step display on the pattern G using the mouse 204 or the like, the display switches to the screen display of the completed step corresponding to the selected step display. Using this icon function, simply by selecting the step display of the pattern G, the operator can quickly proceed to an operation screen for a desired step and perform an operation over again, for example.

Exemplary Measurement Operation and Guidance Display

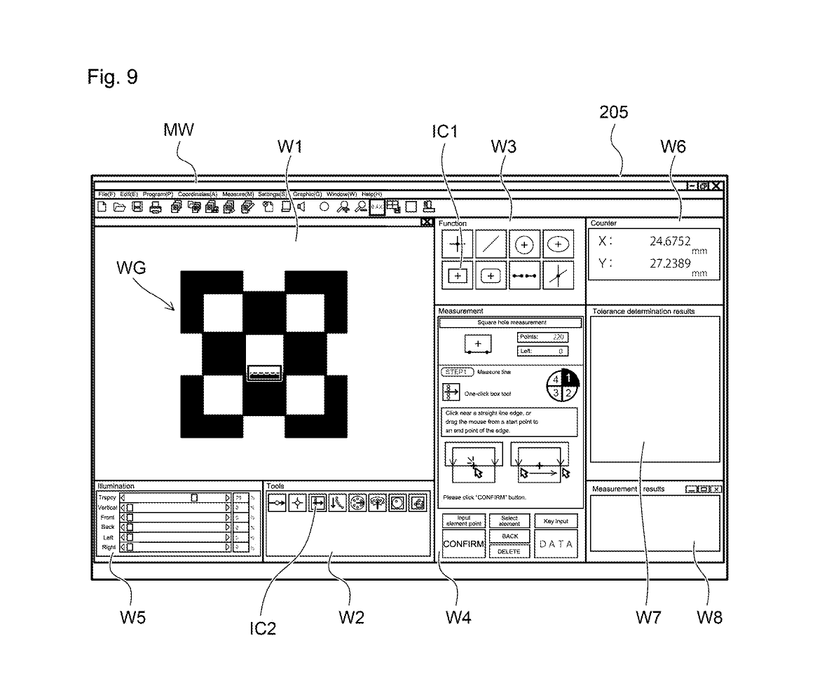

Next, examples of measurement operation and guidance display are described. FIGS. 9 to 16 illustrate examples of measurement operation and guidance display. In this example, an operation measuring a square hole of the work piece W is described. First, when the image of the work piece W is obtained by the image capture unit 15, the image of the work piece W is displayed in the first window W1 of the display 205, as shown in FIG. 9. Using the mouse 204, for example, the operator selects an icon IC1 for selecting square hole measurement on the third window W3. The operator also selects a tool for designating the square hole on the fifth window W5. This example treats an icon IC2 for a box tool as selected. Accordingly, a box tool BT for designating one side of the square hole in the image WG is displayed in the first window W1.

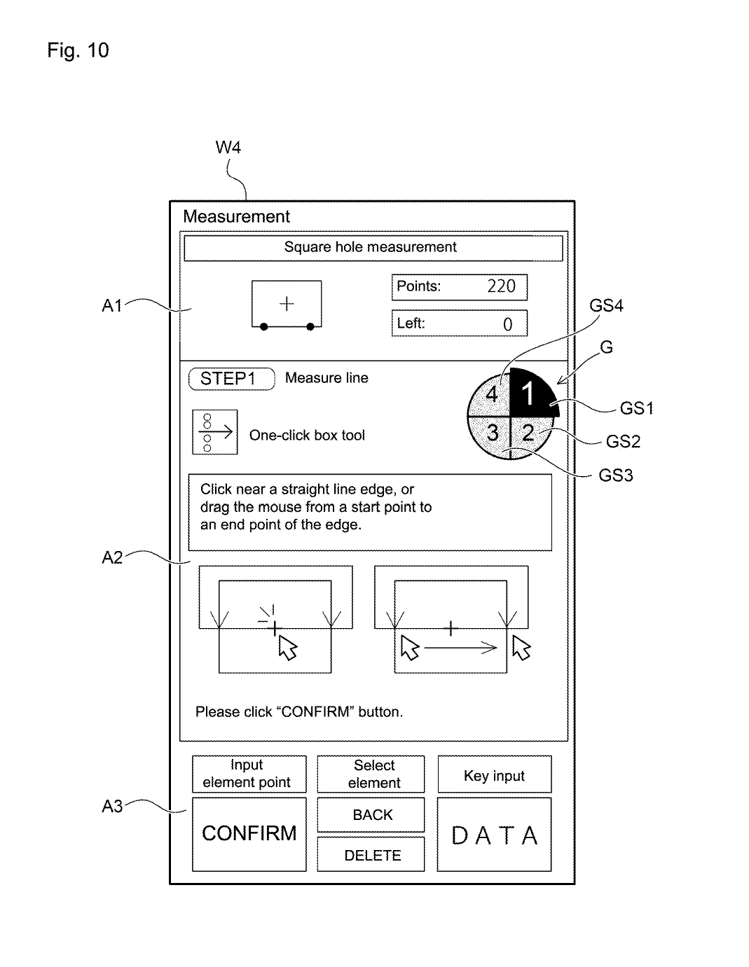

As shown in FIG. 10, guidance display for this stage is given in the fourth window W4. The first area A1 of the fourth window W4 shows a display indicating that the measurement method is square hole measurement and an image indicating the location of the square hole to be designated by the tool. In addition, the second area A2 shows a display indicating that the current operation step is the first step (the words “STEP1” in FIG. 10) and a summary of the location to be designated (“measure line” in FIG. 10). An image indicating that the box tool has been selected is also displayed.

Moreover, guidance display indicating the operation of the first step is given in the second area A2. In the example shown in FIG. 10, the words “Click near a straight line edge, or drag the mouse from a start point to an end point of the edge.” are displayed as the guidance display. The operator refers to the guidance display and operates the mouse 204, then designates one side of the square hole in the image WG.

Moreover, the second area A2 displays the pattern G corresponding to the operation step related to the square hole measurement. In a case where the operator has selected the square hole measurement, the pattern G corresponding to the number of operation steps for performing the measurement (“4”) is displayed. In this pattern G, the first through fourth step displays GS1 to GS4 are arranged in step order around the circle. In the example shown in FIG. 10, a pattern G is displayed in which the circle is divided into four segments, in each of which the 90°, pie-shaped first through fourth step displays GS1 to GS4 are arranged.

Because this stage is the first of the four steps, the first step display GS1 in the pattern G is displayed in a different format from the other step displays. By referring to the guidance display and the pattern G displayed in the second area A2, the operator can readily comprehend that a total of four steps are required for the square hole measurement and that the current step is the first step.

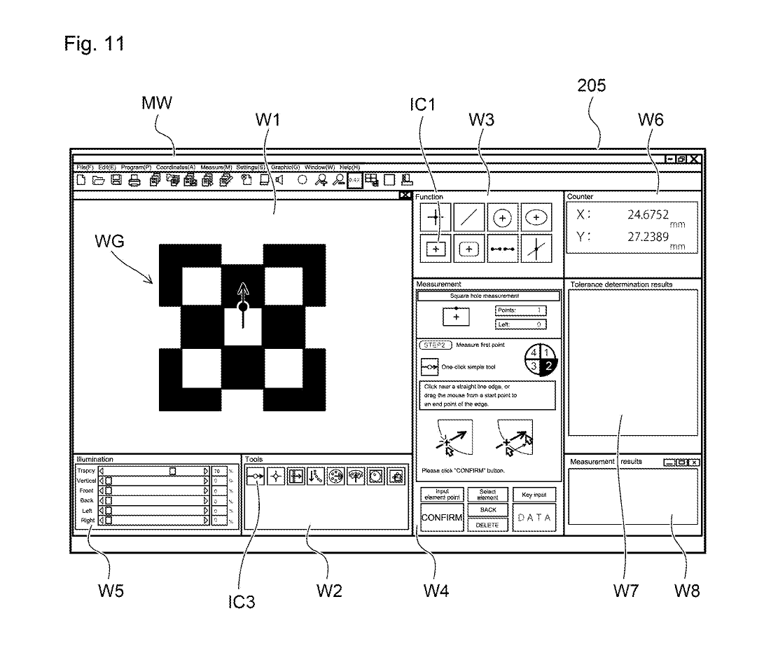

After the operator has designated the one side of the square hole in the image WG, when a “CONFIRM” button in the third area A3 is selected, the designated side of the square hole is confirmed. Next, the display advances to the screen display of the second step, shown in FIG. 11. In the second step of measuring the square hole, an operation is performed to designate one of the three sides of the square hole other than the one side designated in the first step. The operator selects a tool for designating the side on the fifth window W5. This example treats an icon IC3 for a simple tool as selected. Accordingly, a simple tool ST for designating one side of the square hole in the image WG is displayed in the first window W1.

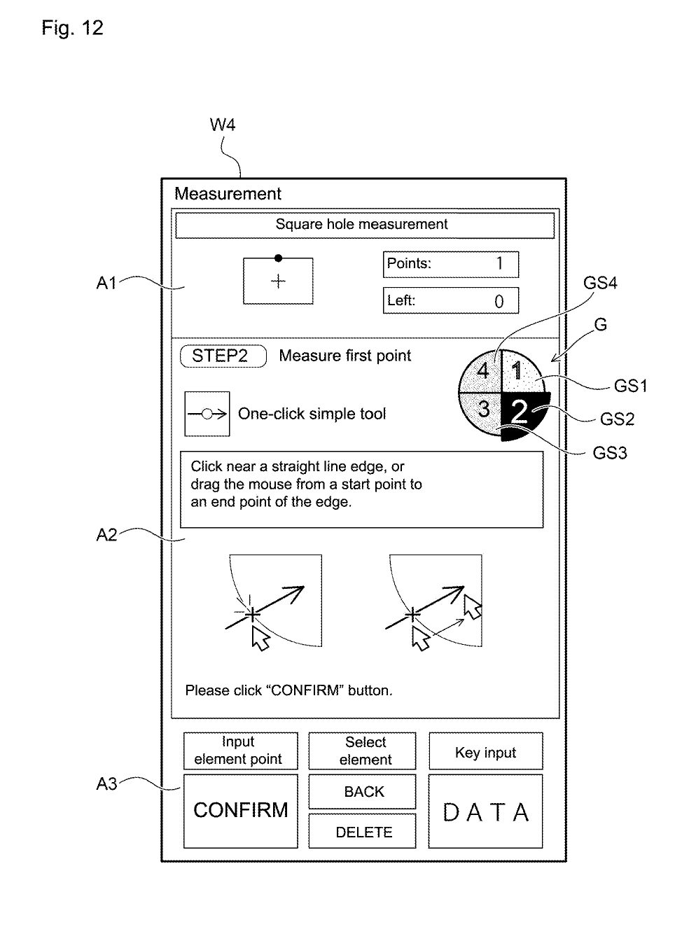

As shown in FIG. 12, the guidance display for this stage is given in the fourth window W4. The first area A1 of the fourth window W4 shows a display indicating that the measurement method is square hole measurement and an image indicating the location of the square hole to be designated by the tool. In addition, the second area A2 shows a display indicating that the current operation step is the second step (the words “STEP2” in FIG. 12) and a summary of the location to be designated (“measure first point” in FIG. 12). An image indicating that the simple tool has been selected is also displayed.

Moreover, guidance display indicating the operation of the second step is given in the second area A2. In the example shown in FIG. 12, the words “Click near an edge, or drag the mouse in a scan direction from near an edge.” are displayed as the guidance display. The operator refers to the guidance display and operates the mouse 204, then designates one side of the square hole in the image WG.

Moreover, in the pattern G displayed in the second area A2, the second step display GS2 is the current step display and is displayed in a different format from the other step displays. In the pattern G, the first step display GS1 (completed step display) is shown in a pale color, whereas the third step display GS3 and the fourth step display GS4 (pending step displays) are shown in a dark color. By referring to the pattern G displayed in the second area A2, the operator can readily comprehend that the current step is the second out of a total of four steps.

In this example, in a case where the pattern G has the icon function, when the first step display GS1 of the pattern G is selected using the mouse 204 or the like, the process can return to the screen shown in FIGS. 9 and 10 for the first step and the operation can be performed over again. This icon function operates similarly for the following steps, as well.

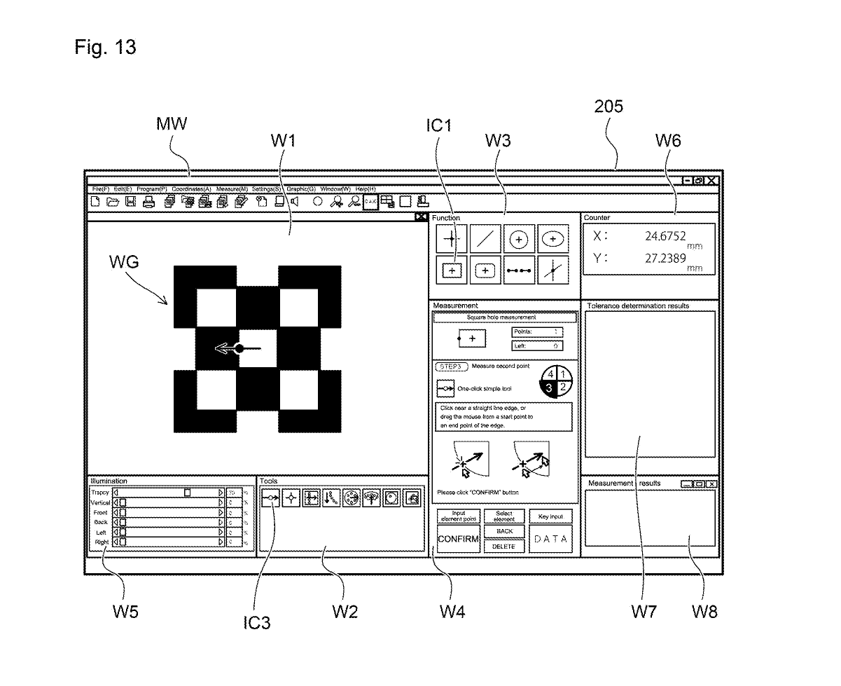

After the operator has designated the one side of the square hole in the image WG, when the “CONFIRM” button in the third area A3 is selected, the designated side of the square hole is confirmed. Next, the display advances to the screen display of the third step, shown in FIG. 13. In the third step of measuring the square hole, an operation is performed to designate one of the two sides of the square hole other than the sides designated in the first and second steps. The operator selects a tool for designating the side on the fifth window W5. This example treats the icon IC3 for the simple tool as selected. Accordingly, the simple tool ST for designating one side of the square hole in the image WG is displayed in the first window W1.

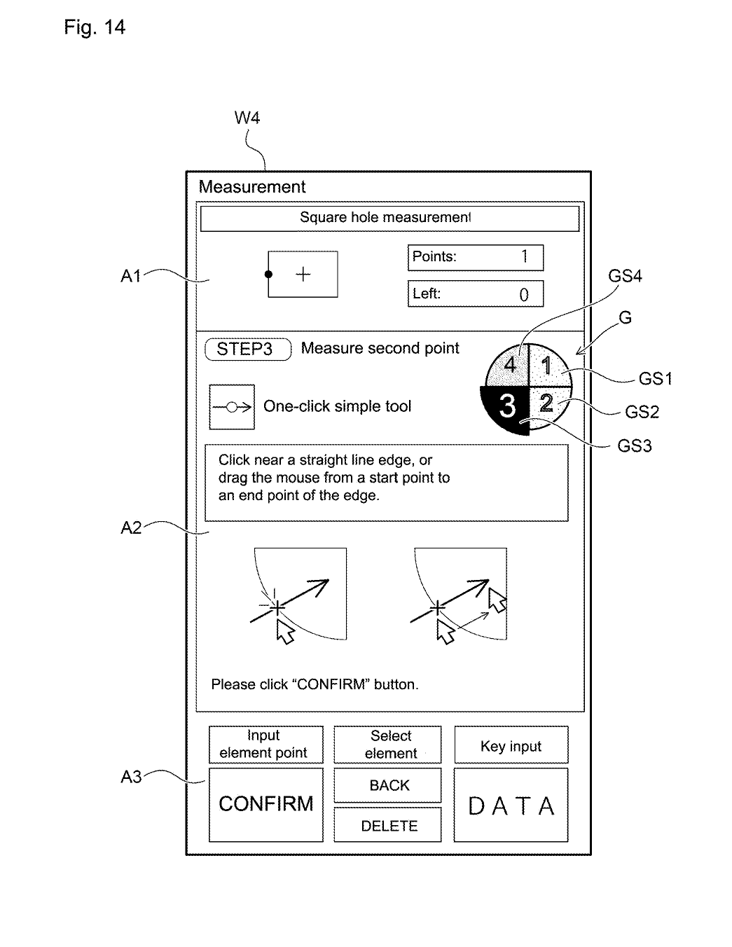

As shown in FIG. 14, guidance display for this stage is given in the fourth window W4. The first area A1 of the fourth window W4 shows a display indicating that the measurement method is square hole measurement and an image indicating the location of the square hole to be designated by the tool. In addition, the second area A2 shows a display indicating that the current operation step is the third step (the words “STEP3” in FIG. 14) and a summary of the location to be designated (“measure second point” in FIG. 14). An image indicating that the simple tool has been selected is also displayed.

Moreover, guidance display indicating the operation of the third step is given in the second area A2. In the example shown in FIG. 14, a display is given that is identical to the guidance display in the second step shown in FIG. 12. The operator refers to the guidance display and operates the mouse 204, then designates one side of the square hole in the image WG.

Moreover, in the pattern G displayed in the second area A2, the third step display GS3 is the current step display and is displayed in a different format from the other step displays. In the pattern G, the first step display GS1 and the second step display GS2 (completed step displays) are shown in a pale color, whereas the fourth step display GS4 (pending step display) is shown in a dark color. By referring to the pattern G displayed in the second area A2, the operator can readily comprehend that the current step is the third out of a total of four steps.

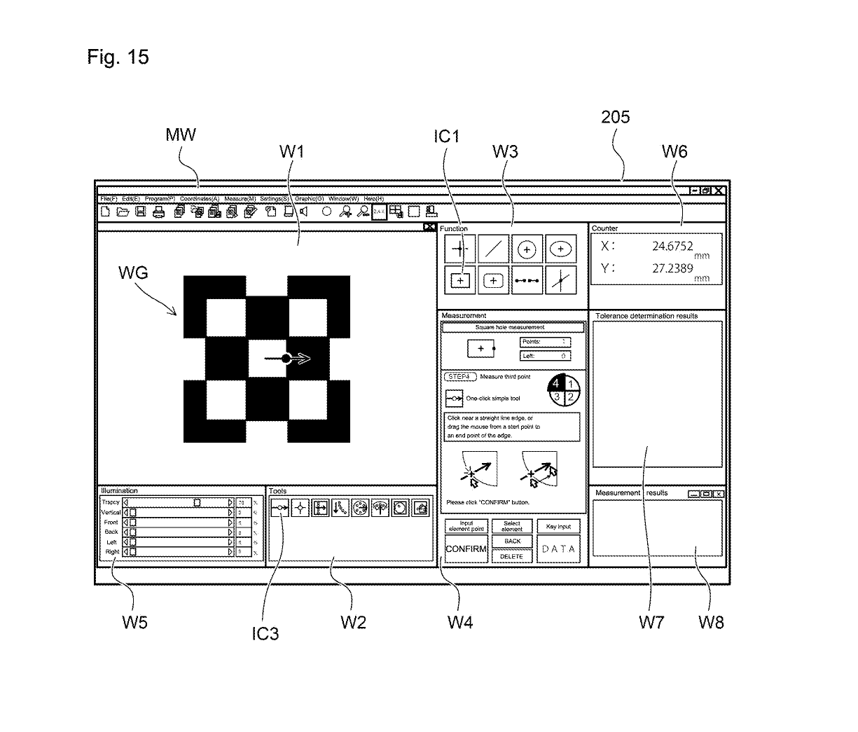

After the operator has designated the one side of the square hole in the image WG, when the “CONFIRM” button in the third area A3 is selected, the designated side of the square hole is confirmed. Next, the display advances to the screen display of the fourth step, shown in FIG. 15. In the fourth step of measuring the square hole, an operation is performed to designate the final side of the square hole. The operator selects a tool for designating the side on the fifth window W5. This example treats the icon IC3 for the simple tool as selected. Accordingly, the simple tool ST for designating one side of the square hole in the image WG is displayed in the first window W1.

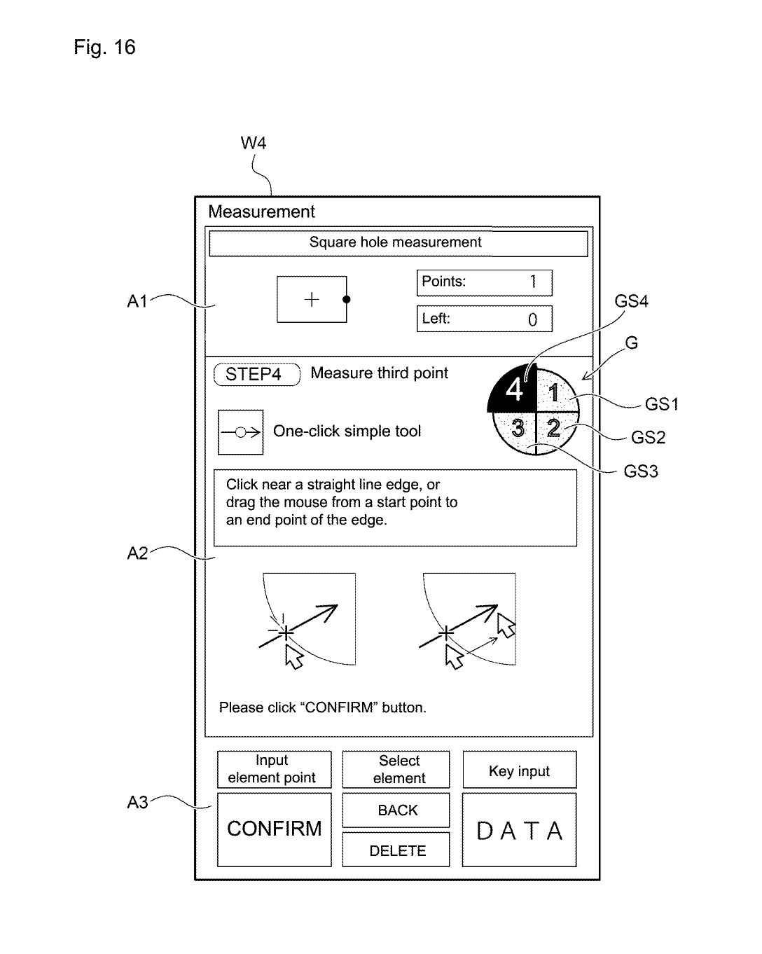

As shown in FIG. 16, the guidance display for this stage is given in the fourth window W4. The first area A1 of the fourth window W4 shows a display indicating that the measurement method is square hole measurement and an image indicating the location of the square hole to be designated by the tool. In addition, the second area A2 shows a display indicating that the current operation step is the fourth step (the words “STEP4” in FIG. 16) and a summary of the location to be designated (“measure third point” in FIG. 16). An image indicating that the simple tool has been selected is also displayed.

Moreover, guidance display indicating the operation of the third step is given in the second area A2. In the example shown in FIG. 16, a display is given that is identical to the guidance displays in the second and third steps shown in FIGS. 12 and 14, respectively. The operator refers to the guidance display and operates the mouse 204, then designates one side of the square hole in the image WG.

Moreover, in the pattern G displayed in the second area A2, the fourth step display GS4 is the current step display and is displayed in a different format from the other step displays. In this pattern G, the first to third step displays GS1 to GS3 (completed step displays) are displayed in a pale color. By referring to the pattern G displayed in the second area A2, the operator can readily comprehend that the current step is the fourth out of a total of four steps.

After the operator has designated the one side of the square hole in the image WG, when the “CONFIRM” button in the third area A3 is selected, the designated side of the square hole is confirmed. When all sides of the square hole are confirmed, calculations of the size, position, area, and the like of the square hole are performed based on the data for the designated sides of the square hole, and measurement results are displayed in the eighth window W8.

Because guidance display and pattern G display corresponding to the selected measurement are provided in this way, the operator can comprehend at a glance the operation sequence required for measurement and also the progress (how many total steps there are, and which is the current step).

In the above example, a case measuring a square hole was described; however, guidance display and pattern G display corresponding to the operator-selected measurement are provided in a similar manner for other measurements as well. With such displays, even when unfamiliar with the measurement method, the operator can accurately perform operations in accordance with the guidance display and can readily comprehend the total number of steps to complete the measurement and the current progress.

Image Measurement Program

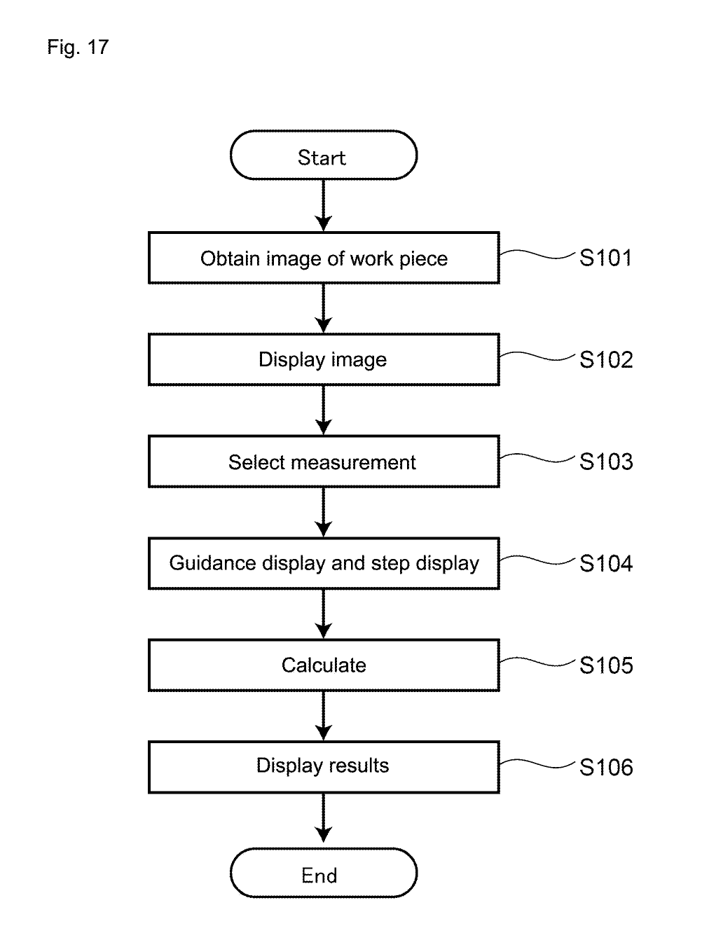

A guidance display method of the image measurement apparatus 1 in the present embodiment is provided as a portion of an image measurement program executed by the CPU 211 of the computer system 20. FIG. 17 is a flow chart illustrating an exemplary flow of the image measurement program. First, in “obtain image of work piece” shown in step S101, a process is performed obtaining an image of the work piece W using the image capture unit 15. Next, in “display image” shown in step S102, a process is performed displaying the image of the work piece W obtained using the image capture unit 15 on the display 205.

Next, in “select measurement” shown in step S103, a process is performed receiving a selection of a measurement by the operator. For example, a determination is made as to which measurement was selected using the icon of the function in the third window W3 by the operator operating the mouse 204.

Next, in “guidance display and step display” shown in step S104, an operation sequence is selected in accordance with the measurement method selected by the operator, and the guidance display matching that operation sequence and the pattern G showing the operation steps are displayed.

Next, in “calculate” shown in step S105, calculations are performed to obtain measurement results based on the location in the image WG selected by the operator. Thereafter, in “display results” shown in step S106, a process is performed to display the results of the calculation as measurement results on the display 205.

Using an image measurement program of this kind, the operator can accurately perform the desired measurement in accordance with the guidance display. In addition, the operator can readily comprehend the total number of operation steps required for the measurement and the current step (progress) using the pattern G display.

The image measurement program described above may be stored on the computer-readable memory medium MM, or may be distributed over a network.

As described above, according to the present embodiment, when performing guidance display, the image measurement apparatus 1 and the guidance display method of the image measurement apparatus 1 can be provided which enable the progress of a measurement task to be readily comprehended.

An embodiment and specific examples are described above. However, the present invention is not limited to these examples. For example, a display format, displayed items, or the like for each window are not limited to those described above. With respect to the above-described embodiment or specific examples, a person skilled in the art can perform suitable addition, deletion, and design modification of configuration elements, and such modifications are also included in the scope of the present invention as long as they fall within the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An image measurement apparatus comprising:
an image capturer configured to obtain an image of an object to be measured;
an image display configured to display the image obtained by the image capturer;
a measurer configured to perform a measurement selected by an operator based on the image displayed on the image display;
a guidance display configured to display an operation sequence for the measurement on the image display; and
a step display configured to display, on the image display, a pattern corresponding to an operation step in the operation sequence, wherein the step display is further configured to display, as the pattern, a step display for each of the operation steps in a circular form in operation order.

2. The image measurement apparatus according to claim 1, wherein the step display is further configured to display a current step display corresponding to the current operation in a format different from the other step displays.

3. The image measurement apparatus according to claim 2, wherein the step display is further configured to display the current step display and the other step displays at mutually different area ratios.

4. The image measurement apparatus according to claim 2, wherein the step display is further configured to display the current step display with a size larger than the other step displays.

5. The image measurement apparatus according to claim 2, wherein the step display is further configured to display the current step display in a color different from the other step displays.

6. The image measurement apparatus according to claim 2, wherein the step display is further configured to display a step earlier in the operation order than the current step display, and in a color paler than the current step display.

7. The image measurement apparatus according to claim 2, wherein the step display is further configured to display a step later in the operation order than the current step display in a color paler than the current step display and in a different color from that of the step display earlier in the operation order than the current step display.

8. The image measurement apparatus according claim 1, wherein the step display is further configured to display, as the pattern, all of the step displays arranged as one complete circle.

9. The image measurement apparatus according to claim 1, wherein the step display is further configured to display each of the step displays as individual pie-shaped segments.

10. A guidance display method of an image measurement apparatus, which obtains and displays an image of an object to be measured on a display and which performs a measurement selected by an operator based on the image displayed on the display, the method comprising:
displaying, on the display of the image measurement apparatus, an operation sequence for a measurement and a pattern corresponding to an operation step of the operation sequence; and
displaying, as the pattern, each step display of the operation steps in a circular form in operation order.

11. The guidance display method according to claim 10, further comprising displaying, as the pattern, a current step display corresponding to the current operation step in a format different from the other step displays.

12. The guidance display method according to claim 11, further comprising displaying, as the pattern, the current step display and the other step displays at mutually different area ratios.

13. The guidance display method according to claim 11, further comprising displaying, as the pattern, the current step display with a size larger than the other step displays.

14. The guidance display method according to claim 11, further comprising displaying, as the pattern, the current step display in a color different from the other step displays.

15. The guidance display method according to one of claim 11, further comprising displaying, as the pattern, a step display earlier in the operation order than the current step display in a color paler than the current step display.

16. The guidance display method according to claim 11, further comprising displaying, as the pattern, a step display later in the operation order than the current step display in a color paler than the current step display and in a different color from that of the step display earlier in the operation order than the current step display.

17. The guidance display method according to claim 10, further comprising displaying, as the pattern, all of the step displays arranged as one complete circle.

18. The guidance display method according to claim 10, further comprising displaying, as the pattern, each of the step displays as individual pie-shaped segments.
